(19) United States
(12) Patent Application Publication
(10) Pub. No.: US 2010/0279159 A1
(43) Pub. Date: Nov. 4, 2010

(54) Electrochemical Cell and Battery

(75) Inventors: Jens Meintschel, Bernsdorf (DE); Dirk Schroeter, Winnenden (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/528,748

(22) PCT Filed: Feb. 26, 2008
(86) PCT No.: PCT/EP2008/001496

§ 371 Date: Jul. 16, 2010

(30) Foreign Application Priority Data
Feb. 27, 2007 (DE) 10 2007 010 750.3

(51) Int. Cl. H01M 6/10

(52) U.S. Cl. 429/94

(57) ABSTRACT

The invention relates to an electrochemical single cell for a battery, and battery made from said single cells. The single cell comprises an electrode stack wound around a heat conducting bar and/or folded around a heat conducting bar. For the control of the single cell, the heat conducting bar is at least partly made from a highly heat-conductive material on the surface thereof turned towards the electrode stack and is formed as a solid. So as to ensure economical and simple temperature management of a battery, the heat conducting bar is connected to a temperature control unit in a heat conducting manner with the battery.

The invention relates to an electrochemical single cell for a battery and a battery made from said single cells, according to the preamble of claim 1 or the preamble of claim 9, as both are known for example from the generic DE 103 58 582 A1 taken as a basis.

From DE 103 58 582 A1 is known an electrochemical single cell for a battery as is used especially for the production of high performance batteries. These batteries are preferably used for the at least partial drive of motor vehicles transporting passengers, as automobiles or buses. The preferred battery systems are especially Li ion batteries and/or NiMH batteries, where several single cells are connected to one another in parallel or in series. The previously known single cell is a multilayer electrode stack of foils, two electrode foils with a separator foil arranged therebetween, preferably Al/separator/Cu wound around a cooling pipe, wherein the cooling pipe is in any case already used as a mounting aid. It can also be folded around the cooling pipe as an alternative to the winding of the electrode stack around the cooling pipe. For the electrically conducting contacting with an electrode foil, the cooling pipe is made of a highly electrically conductive material at its surface turned towards the electrode stack. A cooling channel is arranged in the interior of the cylindrical cooling pipe for the later heat conducting contact. The cooling channel is filled with a temperature-dependent phase changing, especially evaporating material in a convenient manner, and is connected to the outer region of the single cell in a heat-diverting manner.

From US 2002/0064707 A1 is known a battery whose single cells have a preferably regular hexagonal cross section. A cooling channel is respectively arranged in the interior of respectively six single cells. The cooling channel is hereby formed by the walls of the single cells, which are arranged in direct contact to another around the cooling channel. The cross section of the cooling channel thus corresponds to the one of the single cells in its form and dimensions. By this arrangement of the cooling channel, the six single cells abutting each cooling channel abut cooling channel with respectively one of their outer sides. The temperature control, especially the cooling of the single cells, takes place via the cooling channels.

In both cases, the temperature control requires either a complicated arrangement of the cooling channel or a space demand which can otherwise be used in a different manner. The previously known is thereby at least cost-intensive.

It is the object of the invention to enable a temperature control of a battery which is as cost-efficient and as space-saving as possible.

The object is solved with a single cell with the characteristics of claim 1 or with a battery with the characteristics of claim 9. According to the invention, a heat conducting bar of a solid is used with an electrochemical single cell for a battery. By increasing the heat-conducting cross section of the material of the heat conducting bar, an efficient and space-saving heat diversion from the cell is ensured. The electrode stack formed of two electrode foils with a separator foil arranged therebetween is wound around the heat conducting bar made of heat-conducting solid and/or is folded around the heat conducting bar. The heat conducting bar is at least in sections made of an electrically and/or heat conducting material on its surface turned towards the electrode stack.

In a convenient manner, the heat conducting bar is connected to a heat collecting unit and/or a temperature control outside the single cell in a heat-conducting manner, but preferably still within its associated battery box. With a battery consisting of several single cells connected in parallel or in series, the heat collection unit collects the heat amount passed thereto from the heat conducting bars. The heat amount is removed therefrom possibly with the aid of further components. When a temperature control unit is used, the temperature control unit provides the temperature by taking on the present heat amount of the heat conducting bars to be transported and removes them and/or conducts a required heat amount to the heat conducting bars.

The temperature control unit comprises an evaporator plate in a further arrangement, which on its part is connected to a cooling coil in a sensible manner.

In a further arrangement, the material of the heat conducting bar is an easily available metal or a metal alloy, especially aluminum or aluminum alloy and/or copper or copper alloy.

For the dense stacking of single cells, the cross section of the heat conducting bar is triangular to octagonal, preferably equilaterally triangular to octagonal in a further arrangement of the invention. However, all prismatic or oval cross sections are feasible in principle.

In a further arrangement, the electrode stack is arranged in a cell housing preferably of metal. Hereby it is possible amongst others to contact a single cell electrically via the cell housing and/or to additionally carry out the temperature control via the cell housing.

In a further arrangement, the electrode stack is arranged in an electrically conducting cell housing, and the heat conducting bar is connected to a single electrode type of the electrode stack in an electrically conducting manner. The cell housing is further connected to the other electrode type in an electrically conducting manner and that cell housing and the heat conducting bar are electrically insulated from one another. The two poles of the single cell are thereby then formed by the heat conducting bar and by the cell housing of the single cell.

Single cells according to the invention can especially be used for high performance batteries, especially for the at least partial drive of a motor vehicle for passenger transport.

Further sensible arrangements can be taken from the further dependent claims. The invention is further explained by means of the embodiments shown in the drawings. It shows thereby:

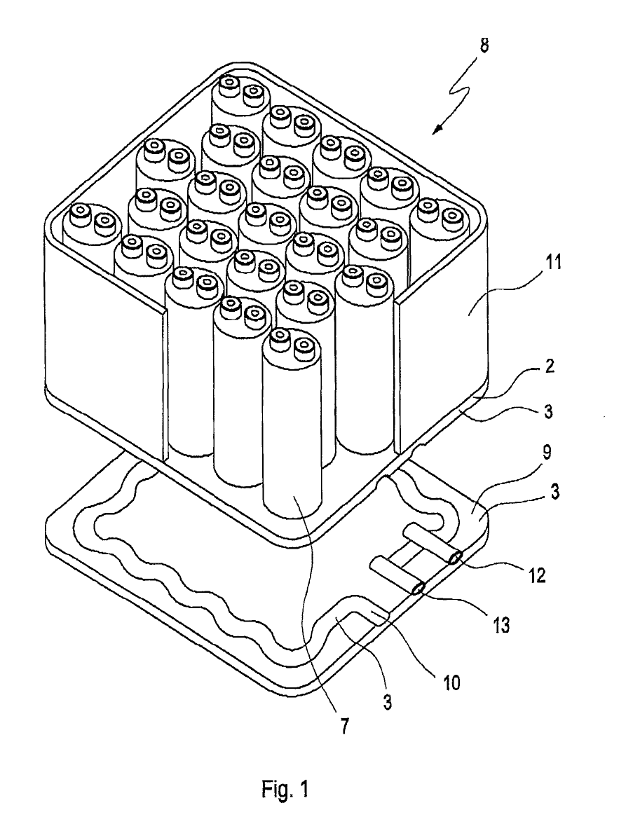

FIG. 1 a battery formed of round single cells with evaporator plate and cooling coil,

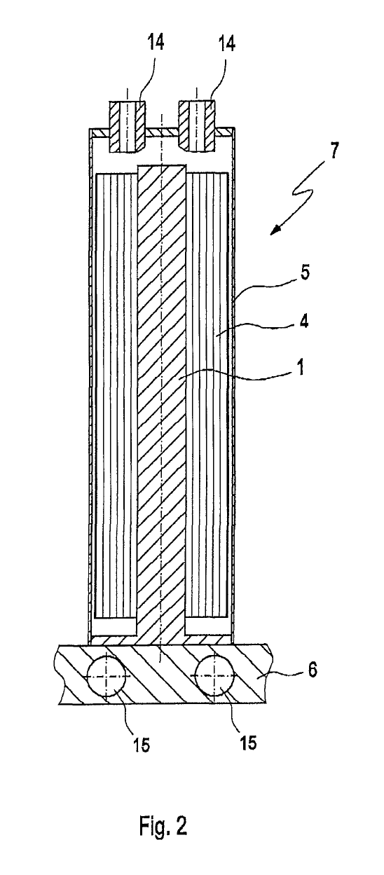

FIG. 2 a longitudinal section through a single cell according to FIG. 1,

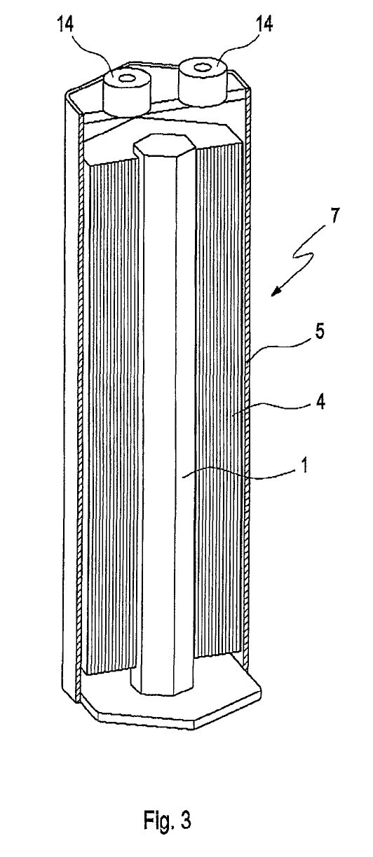

FIG. 3 a longitudinal section through a single cell with a regular hexagonal cross section,

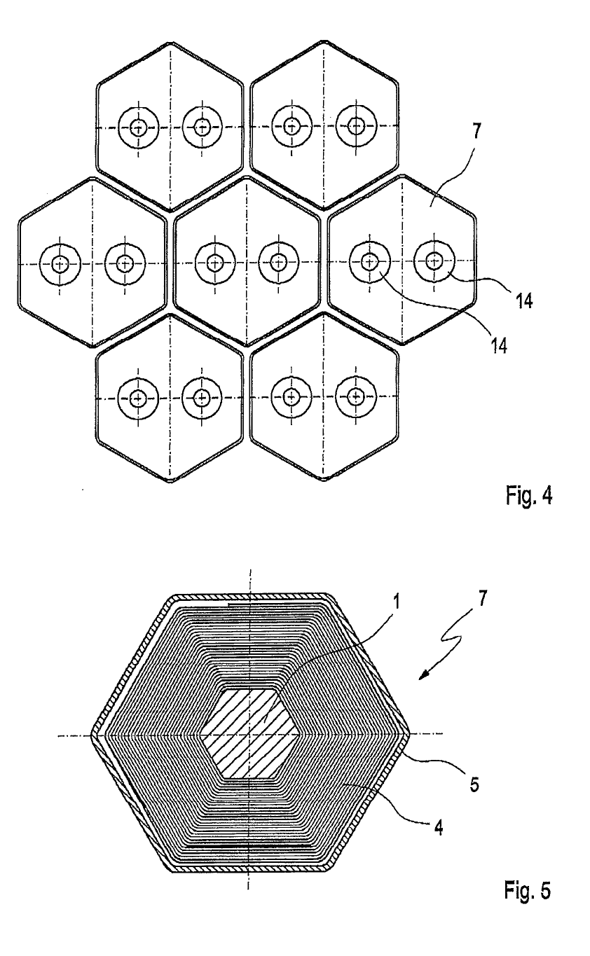

FIG. 4 a plan view on a stack of several single cells according to FIG. 3,

FIG. 5 a transverse section through a single cell according to FIG. 3, and

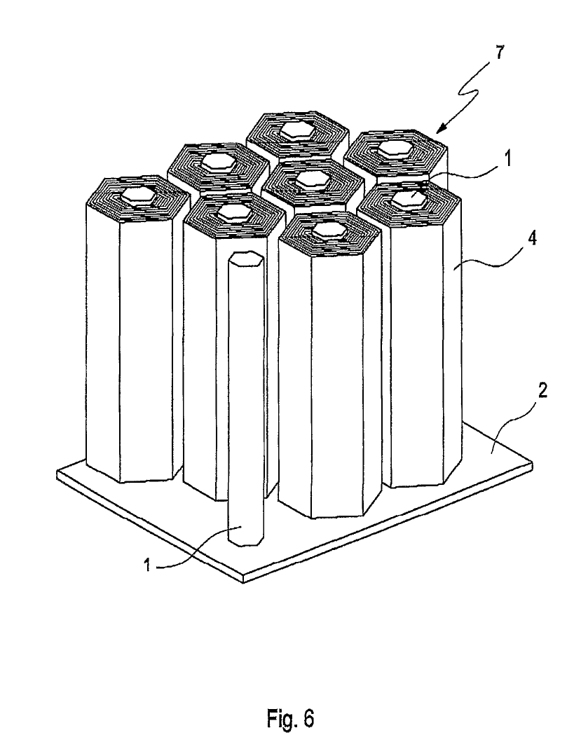

FIG. 6 an integrated battery with several single cells without housing.

In FIG. 1 is shown a battery 8, which amongst others consists of several electrically connected single cells 7. The single cells are arranged in an especially completely closed battery housing 11. The single cells 7 are arranged on a heat conducting unit 2 formed as a metal plate. The arrangement of the single cells 7 on the heat conducting unit 2 takes place with the longitudinal axes parallel to one another, wherein the heat conducting bars 1 of the individual single cells 7 are connected to the heat conducting unit 2 in a heat-conducting manner.

The heat conducting unit 2 forms, together with a base plate 9 and a cooling coil 10 arranged between these two plates 2, 9, a temperature control unit 3 for at least one part of the single cells 7 of the battery 8. By means of the temperature control unit 3, it is possible to influence the temperature within the single cells 7 connected thereto in a heat-conducting manner in an advantageous manner in a simple and cost-effective manner.

In a sensible manner, the cooling coil 10 can additionally be connected to an air conditioning unit (not shown) already present in a vehicle via its connections 12, 13 and be supplied by this at least partially on the heat side. This heat supply can be connected directly to the air conditioning unit, for example via a common heat conducting medium, especially a fluid, but it can also cooperate indirectly with the air conditioning unit, for example via a heat exchanger. In a preferred manner, the heat conducting medium can also be the air escaping from the air-conditioned interior of the vehicle and/or be supplied with this air.

In FIG. 2 is shown a longitudinal section through a single cell 7 according to FIG. 1. The single cell 7 according to the invention comprises a heat conducting bar 1 with a circular cross section in its center, around which is wound an electrode stack 4 of a multilayer electrochemically active foil. The heat conducting bar 1 is made of a highly heat-conductive solid, wherein these are not only meant to be monolithically compact and continuous bodies, but also porous bodies, as for example cast or sintered bodies. As material for the heat conducting bar 1, a metal and preferably aluminum and/or copper or such an alloy is chosen.

The wound electrode stack 4 with the heat conducting bar 1 as a core is arranged within a closed cell housing 5. The two electrodes of the electrode stack 4 are connected to their respective electrical pole 14 for current diversion in a known manner via current diverter vanes (not shown). In this embodiment, the heat conducting bar 1 and the cell housing 5 are electrically insulated with regard to the two electrodes of the electrode stack 4. The heat conducting bar 1, which is sensibly simultaneously formed as the base of the cell housing 5, is preferably defined in a fixed manner and placed affixed in a heat-conducting manner on the temperature control unit formed as evaporator plate 6.

Alternative to the current diversion via the poles 14, the electrodes of the electrode stack 4 can also be connected to the cell housing 5 and/or to the heat conducting bar 1. For this, the cell housing 5 and the heat conducting bar 1 have to be made of an electrically conductive material at least in sections.

Furthermore, they then have to be insulated from one another and possibly still further conventionally known or obvious and self-evident measures have to be taken.

Such an evaporator plate 6 of the state of the art comprises an evaporator section and a condensation section arranged in the region of the single cells 7, which is outside the battery housing 11. The condensation region is connected to the evaporator region via channels 15. The channels form a closed channel system in their entirety, which is filled with a defined fluid volume of a heat conducting medium. The walls of the channels 15 are lined with a capillary-effective fabric serving for transporting the fluid heat conducting medium from the condensation to the evaporator region.

The cooling of the single cells 7 and thus the battery 8 takes place via the diversion of the heat from the interior of each single cell 7 via their heat conducting bar 1, which on its part passes the heat to be diverted to the evaporator plate 6. By means of the heat passed on, fluid heat conducting medium evaporates in the evaporator section and flows into the condensation region, where it passes the heat to the outside by condensation. The heat conducting medium which is now fluid again is again transported in the direction of the evaporator section by means of the capillary-effective fabric, where it evaporates again.

FIG. 3 shows a longitudinal section through a single cell 7, which is widely constructed similar to the single cell 7 according to FIG. 2. However, the hexagonal cross section of the single cells 7 and of the heat conducting bar 1 deviates from this, wherein the hexagon of the cross section (see FIG. 5) especially has equilateral sides. This cross section can especially amongst others be stacked in an advantageous manner, as can be seen from the view in FIG. 4 on several single cells 7 arranged at one another according to FIG. 3.

In FIG. 6 is shown an integrated battery with several single cells 7 without a housing. In the present embodiment, the electrode stacks 4 are wound around the heat conducting bars 1. However, they do not have cell housings in contrast to the single cells 1 of the previous embodiments. So that no electrode stacks 4 are short-circuited electrically with these arrangements—for example during a movement—the heat conducting bars 1 are rigidly connected to the heat conducting unit 2, especially glued and/or screwed. The described arrangement is introduced into a battery housing and the electrode stacks are connected to the corresponding electrodes corresponding to their charge. By such a design of a battery, its weight can be reduced.

1. Electrochemical single cell for a battery with an electrode stack wound around a cooling pipe and/or folded around a cooling pipe, wherein the cooling pipe is made of a heat-conducting material at least in sections on the surface turned towards the electrode stack,
characterized in that the cooling pipe is formed as a heat conducting bar (1) and that the heat conducting bar (1) is a solid of a preferably highly heat-conductive material.

2. Single cell according to claim 1,
characterized in that the material of the heat conducting bar (1) is a metal.

3. Single cell according to claim 1,
characterized in that the material of the heat conducting bar (1) is aluminum and/or copper.

4. Single cell according to claim 1,
characterized in that the cross section of the heat conducting bar (1) is round.

5. Single cell according to claim 1,
characterized in that the cross section of the heat conducting bar (1) is triangular to octagonal, preferably triangular to octagonal with approximately equilateral sides.

6. Single cell according to claim 1,
characterized in that the heat conducting bar (1) is provided for a later heat-conducting connection to a heat conducting unit (2) and/or temperature control unit (3).

7. Single cell according to claim 1,
characterized in that the wound/folded electrode stack (4) is arranged in a cell housing (5).

8. Single cell according to claim 1,
characterized in that the wound/folded electrode stack (4) is arranged in an electrically conductive cell housing (5), that the heat conducting bar (1) is connected in an electrically conducting manner to a single electrode type of the electrode stack (4), that the cell housing (5) is connected in an electrically conducting manner to the other electrode type, and that the cell housing (5) and the heat conducting bar (1) are electrically insulated from one another.

9. Battery with several electrochemical single cells connected to one another in series and/or in parallel, which single cells respectively have a cooling pipe and a multilayer electrode stack wound around this cooling pipe and/or folded around it, wherein each cooling pipe is made of a heat-conducting material at least in sections,
characterized in that the cooling pipe is formed as a heat conducting bar (1), that the heat conducting bar (1) is a solid of a preferably highly heat-conductive material, and that the heat conducting bar (1) is connected to a heat conducting unit (2) and/or a temperature control unit (3) in a heat-conducting manner.

10. Battery according to claim 9, characterized in that the temperature control unit (3) has an evaporator plate (6).

11. Use of a single cell according to one of claims 1 to 8 as single cell (7) of a high performance battery, especially for the at least partial drive of a motor vehicle for passenger transport.

12. Use of a battery according to one of claims 9 to 10 as a high performance battery, especially for the at least partial drive of a motor vehicle for passenger transport.
